(19) United States
(12) Patent Application Publication
(10) Pub. No.: US 2021/0348708 A1
(43) Pub. Date: Nov. 11, 2021

(54) PIPE COUPLING AND USE THEREOF

(71) Applicant: Farr Better Plumbing, Windsor (CA)

(72) Inventor: Shawn Farr, Windsor (CA)

(21) Appl. No.: 17/308,328

(22) Filed: May 5, 2021

Related U.S. Application Data
(60) Provisional application No. 63/020,125, filed on May 5, 2020.

(51) Int. Cl. F16L 47/02; F16L 37/08; E03C 1/122

(52) U.S. Cl. CPC F16L 47/02; E03C 1/1222; F16L 37/082

(57) ABSTRACT

A pipe coupling is provided for securing end portions of a pair of thermoplastic pipe elements together. The pipe coupling comprises a first half-shell and a second half-shell for receiving the pair of thermoplastic pipe elements, each one of the half-shells comprising a pair of contact surfaces facing the central space; a pivot attachment pivotally connecting the half-shells to one another at the pivoting ends and enabling the half-shells to pivot with respect to one another between a closed state and an open state; a first connector positioned at the connecting end of the first half-shell; and a second connector positioned at the connecting end of the second half-shell, the first connector and the second connector being complimentary to one another and connectable to each other when the half-shells are in the closed state to enable the welding solvent to sealably weld the contact surfaces and the pipe elements together.

### CROSS-REFERENCE TO RELATED APPLICATIONS

This application claims priority to United-States provisional application No. 63/020,125 filed on May 5, 2020, the content of which is incorporated herein by reference in its entirety for all purposes.

### FIELD

The technical field generally relates to a pipe coupling, and more specifically to a pipe coupling suitable to couple two pipes of a drain-waste-vent system by solvent welding or adhesive pipe coupling.

### BACKGROUND

Thermoplastic pipes can be coupled using a variety of techniques. For example, one existing technique involves applying a welding solvent or adhesive on an external surface of a first pipe and/or on an internal surface of a second pipe and inserting an end of the first pipe into an end of the second pipe (i.e., socketed pipes). The welding solvent or adhesive can then “glue” the two pipes together at their ends. Another existing technique involves the use of grooved pipes that can be screwed into one another.

Each of the existing techniques described above has a number of drawbacks. For example, they can require the use of pipe extensions or can be difficult to implement due to the possibly inconvenient positioning of the pipes to couple together. Many challenges still exist in the field of pipe couplings.

### SUMMARY

In one aspect, a pipe coupling for securing end portions of a pair of thermoplastic pipe elements together end-to-end is provided. The pipe coupling comprises: a first half-shell and a second half-shell each having a pivoting end and a connecting end opposite the pivoting end, the first half-shell and the second half-shell each defining a central space for receiving the pair of thermoplastic pipe elements, each one of the half-shells comprising a pair of contact surfaces facing the central space, each of the contact surfaces being engageable with a respective one of the thermoplastic pipe elements after application of a welding solvent to the contact surfaces and/or to an external surface of the thermoplastic pipe elements; a pivot attachment pivotally connecting the half-shells to one another at the pivoting ends and enabling the half-shells to pivot with respect to one another between a closed state in which the connecting ends contact each other and an open state in which the connecting ends are apart from one another; a first connector positioned at the connecting end of the first half-shell; and a second connector positioned at the connecting end of the second half-shell, the first connector and the second connector being complimentary to one another and connectable to each other when the half-shells are in the closed state to enable the welding solvent to sealably weld the contact surfaces and the pipe elements together.

In some embodiments, each half-shell further comprises a lip member separating the pair of surfaces, the lip member protruding away from the contact surfaces and into the central space.

In some embodiments, the lip member of the first half-shell and the lip member of the second half-shell form together a circular protruding element when the pipe coupling is in the closed state, wherein a first one of the thermoplastic pipe elements abuts a first lateral surface of the circular protruding element, and a second one of the thermoplastic pipe elements abuts a second lateral surface of the circular protruding element.

In some embodiments, the first connector is a male connector and the second connector is a female connector complimentary to the male connector.

In some embodiments, the pivot attachment comprises a hinge having at least one bearing positioned on each one of the first and second half-shells, the bearings being connected by an axle.

In some embodiments, the thermoplastic pipe elements are made of PVC, ABS, polycarbonate or polystyrene.

In some embodiments, the contact surfaces are arcuate contact surfaces for fitting cylindrical thermoplastic pipes.

In some embodiments, the pipe coupling is made of a thermoplastic material. In some embodiments, the pipe coupling is made of the same material as the thermoplastic pipe elements.

In some embodiments, at least one of the first connector and the second connector is removable after the welding solvent sealably welds the contact surfaces and the pipe elements together.

In some embodiments, the thermoplastic pipe elements are cylindrical thermoplastic pipes.

In some embodiments, the end of each one of the pipe elements is a plain end.

In some embodiments, the thermoplastic pipe elements are drain-waste-vent (DWV) pipes.

In another aspect, a method for securing end portions of a pair of thermoplastic pipe elements together end-to-end using the pipe coupling as defined herein is provided. The method comprises: applying a welding solvent to at least one of the external surfaces of the thermoplastic pipe elements and to the contact surfaces of the first and second half-shells; positioning the first half-shell around a respective end of each one of the thermoplastic pipe elements; pivoting the second half-shell about the pivot attachment so that the pipe coupling is in the closed state; and maintaining the pipe coupling in the closed state until the welding solvent forms a sealed connection between the pipe coupling and the thermoplastic pipe elements.

Other features will be better understood upon reading of embodiments thereof with reference to the appended drawings.

### BRIEF DESCRIPTION OF THE DRAWINGS

FIG. 1 is a top perspective view of a pipe coupling in a closed state, according to an embodiment.

FIG. 2 is a front view of the pipe coupling of FIG. 1 in a closed state.

FIG. 3A is a top view of the pipe coupling of FIG. 1 in a closed state.

FIG. 3B is a transparent side elevation view of the pipe coupling of FIG. 1 in a closed state.

FIG. 4 is a top perspective view of the pipe coupling of FIG. 1 in an open state.

FIG. 5 is a side elevation view of the pipe coupling of FIG. 1, in an open state and with one pipe end depicted.

FIG. 6 is a transparent bottom view of the pipe coupling of FIG. 1, in an open state and with two pipe ends depicted.

FIG. 7 is a transparent top perspective view of the pipe coupling of FIG. 1 in an open state and with two pipe ends depicted.

FIG. 8 is a top perspective view of a pipe coupling in an open state, wherein the connection member includes a clip.

FIG. 9 is a top perspective view of two half shells each having corresponding male and female fasteners.

### DETAILED DESCRIPTION

In the following description, similar features in the drawings have been given similar reference numerals. In order to not unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

Moreover, it will be appreciated that positional descriptions such as “top”, “bottom”, “under”, “left”, “right”, “front”, “rear”, “adjacent”, “opposite”, “parallel”, “perpendicular”, “inner”, “outer”, “internal”, “external”, and the like should, unless otherwise indicated, be taken in the context of the figures and should not be considered limiting.

The present description generally relates to a pipe coupling suitable to sealably couple two thermoplastic pipes by solvent welding or adhesive pipe coupling.

In the present disclosure, the following terminology and expressions may also be used:

The term “pipe coupling”, as used herein, refers to a device that allows for two thermoplastic pipes or tubes to be joined together, and preferably solvent welded together. The “pipe couplings” of the present description have two portions, each portion being adapted to receive the end of a thermoplastic pipe. Each portion can be of the same diameter to join two pipes of the same diameter or can alternatively have different diameter to join two pipes of different diameter. Similarly, each portion can be made of the same material to accommodate two pipes made of the same material or can alternatively be made of different materials to join two pipes made of different materials.

The term “pipe”, as used herein, refers to a tubular section or hollow tube made of a suitable material such as thermoplastic material. The pipe is usually, but not necessarily, of circular cross-section. The main use of the pipe is for conveying substances which can flow—i.e., liquids and gases, slurries, powders and masses of small solids. Pipes are also mainly used for conveying drinking water, wastewater (i.e., sewage or grey water), chemicals, heating fluid and cooling fluids, foodstuffs, ultra-pure liquids, slurries, gases, compressed air and vacuum system applications. One non-limiting application of the pipes and pipe couplings of the present description is for domestic, commercial and/or industrial water drainage.

The pipes can be thermoplastic pipes, made of a thermoplastic material. Non-limiting examples of thermoplastic material that may be used include at least one of ABS (acrylonitrile butadiene styrene), PVC (polyvinyl chloride), CPVC (post chlorinated polyvinyl chloride), PB-1 (polybutylene), PP (polypropylene), PE (polyethylene), PVDF (polyvinylidene fluoride) and other similar thermoplastic materials.

The term “pipe element”, as used herein, refers to any pipe-like item of component having a pipe-like shape. Pipe elements include pipe stock, pipe fittings such as elbows, caps and tees. A “thermoplastic pipe element” is a pipe element made of a thermoplastic material.

The terms “adhesive” or “welding solvent” refer to a solvent (also referred to as “glue”) that is applied to temporarily dissolve the polymer forming the pipe element at room temperature. When the dissolving occurs, the polymer chains of one component are typically free to move in the solvent and can mingle with other similarly dissolved chains in the other component. Given sufficient time, the solvent typically permeates through the polymer and out into the environment, which causes the chains lose their mobility. This leaves a solid mass of entangled polymer chains which constitutes a solvent weld. The two components can thereby be sealably welded (or “sealably glued”) by the adhesive or welding solvent.

As previously mentioned, the embodiments of the present description may be useful in the field of plumbing, and more particularly in the field of domestic, commercial and/or industrial water drainage. For example, the embodiments of the present description can be used in drain-waste-vent (DWV) systems to sealably connect thermoplastic pipes, for example to drain sewage and/or grey water.

It should be understood that a DWV system is a system that removes sewage and greywater from a building. A DWV system can typically regulate air pressure in the waste-system pipes to aid free flow. DWV pipes are typically used to convey wastewater from residential, commercial and/or industrial buildings via sewer and grey water lines. In such applications, the flow is generally enabled by gravity under relatively low pressures. DWV pipes will be used in the following description as one preferred example of the use of the pipe couplings. However, the pipe couplings of the present description should not be interpreted as being solely limited to DWV pipe systems.

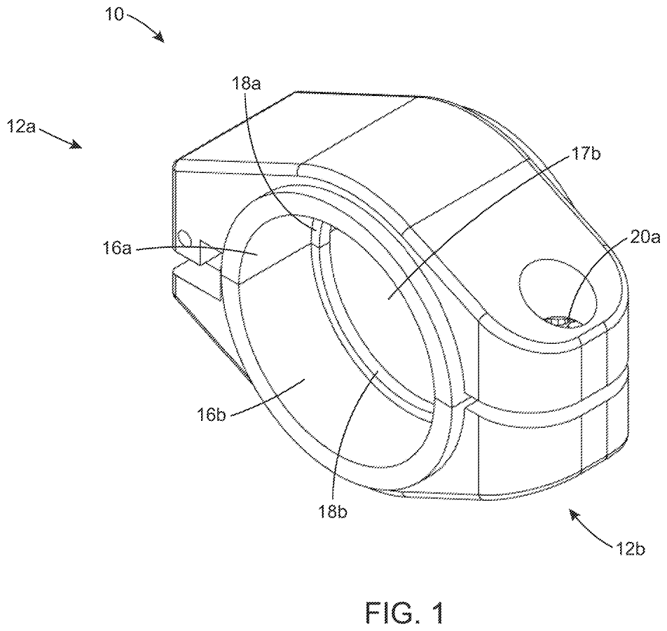

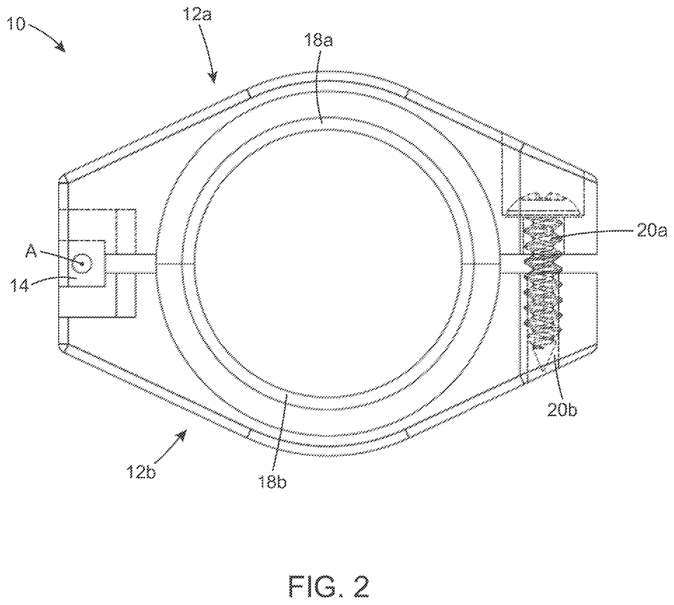

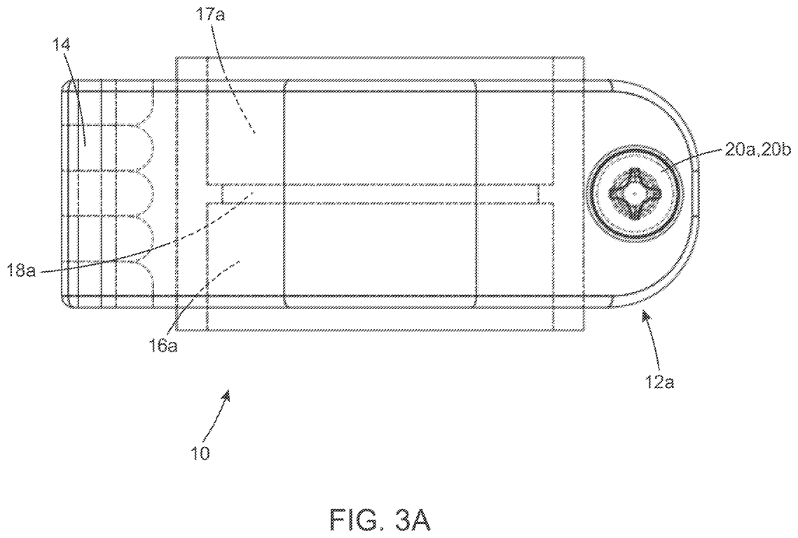

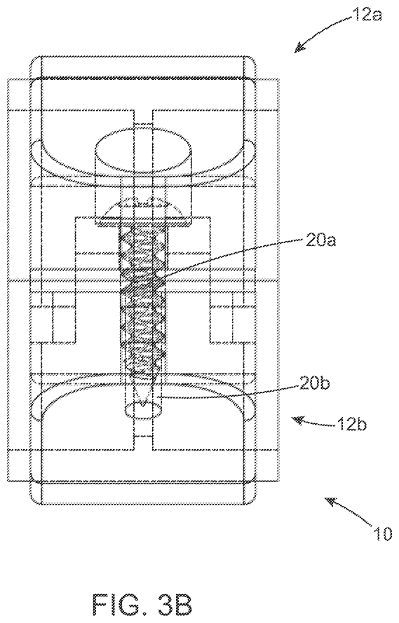

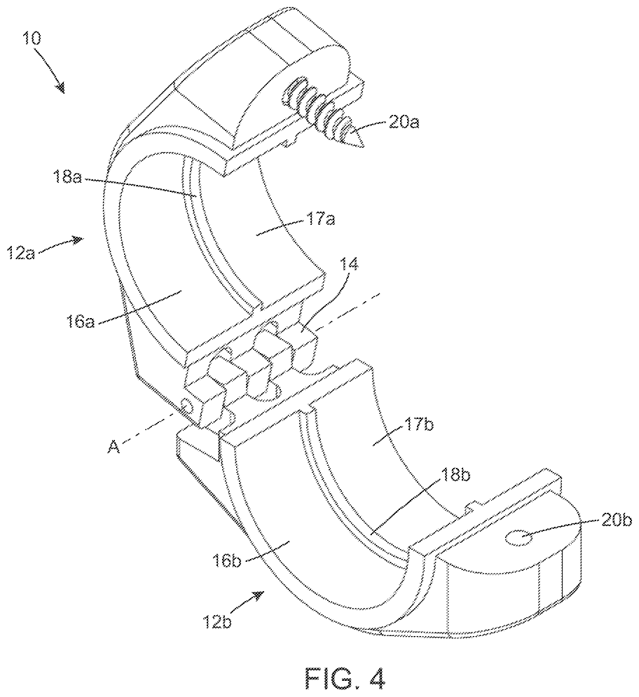

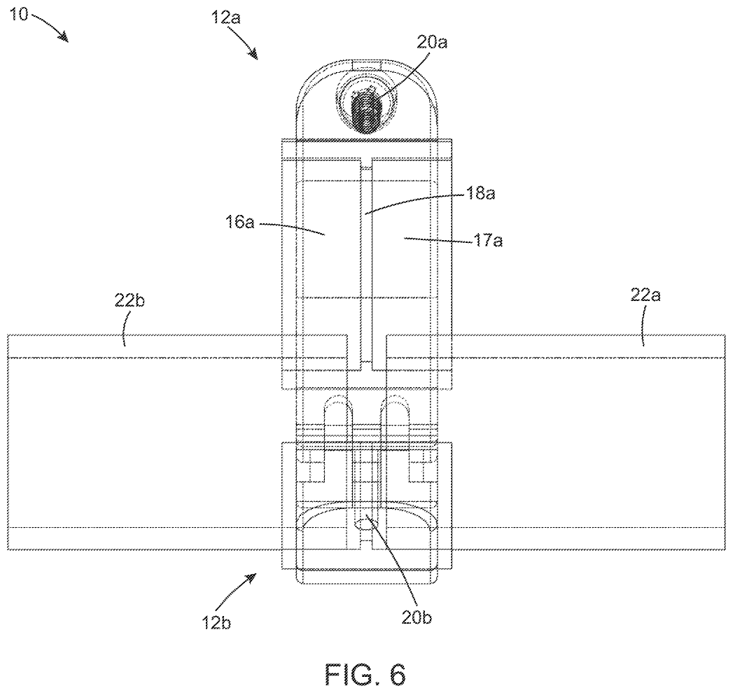

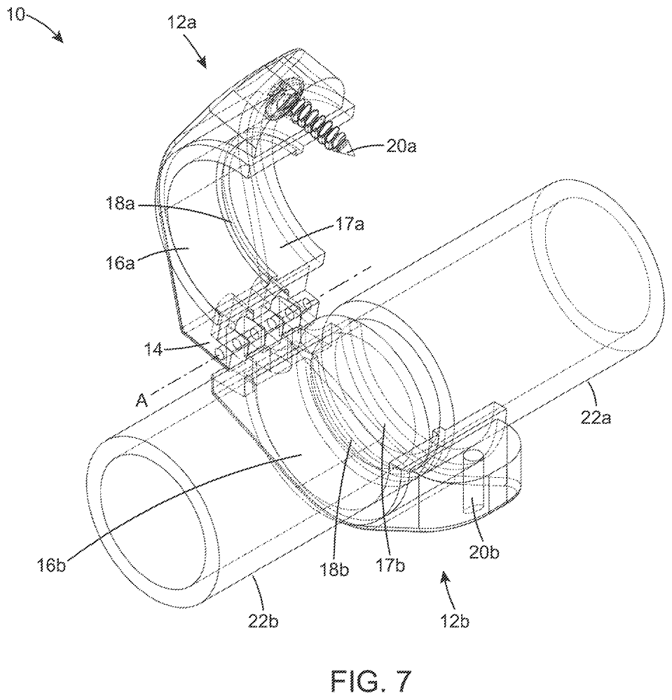

Referring to FIGS. 1-7, a pipe coupling 10 according to an embodiment of the present description, for securing end portions of two thermoplastic pipes together end-to-end is shown in an open state (FIGS. 4, 5, 6 and 7) and in a closed state (FIGS. 1, 2, 3a, and 3b). The pipe coupling 10 has two half-shells 12a, 12b connected end-to-end and surrounding a central space for receiving the two thermoplastic pipes. Each one of the half-shells 12a, 12b includes a first contact surface 16a, 16b and a second contact surface 17a, 17b, each of the contact surfaces being engageable with a respective one of the pipe elements. A welding solvent can be applied to the contact surfaces and/or to an exterior of the end of the pipe elements prior to engaging the pipe elements into the pipe coupling. Each of the two half-shells shown at FIGS. 1-7 and 8 also includes a lip member 18a, 18b protruding outwardly and separating the first contact surface 16a, 16b and the second contact surface 17a, 17b. Each one of the two thermoplastic pipes can be placed on a corresponding side of the lip member 18a, 18b so as to contact the corresponding side surface of the lip member 18a, 18b. In the embodiments shown in the Figures, the lip member 18a, 18b is located substantially in a central portion of the internal surface of the pipe coupling 10, which enables the two thermoplastic pipes to each be inserted into the pipe coupling substantially evenly with respect to each other. It should however be understood that the lip member 18a, 18b is optional.

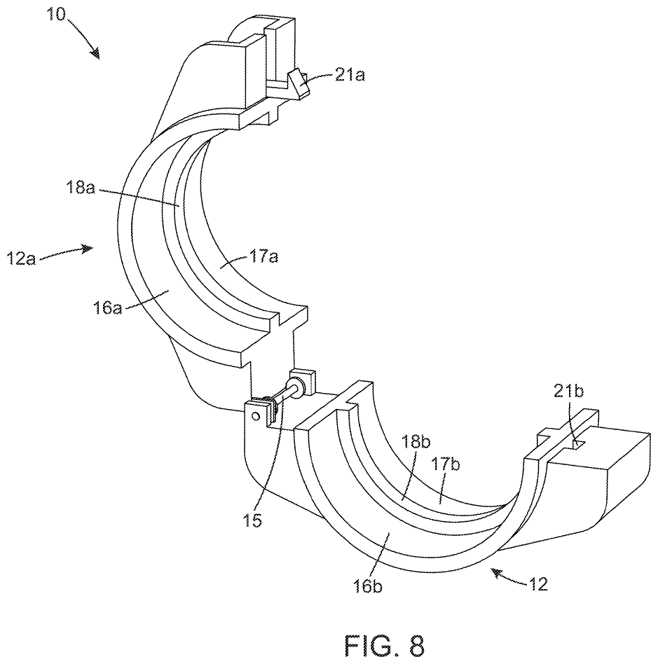

The pipe coupling 10 can also include a pivot attachment 14 positioned on one end of the half-shells and pivotally connecting the half-shells to one another. In the embodiment shown at FIGS. 1-7, the pivot attachment 14 is embodied by a hinge that enables rotational movement of each one of the two half shells 12a, 12b about hinge axis A. It should be understood that other types of pivot attachments 14 can be used, such as the pivot attachment 15 shown at FIG. 8.

Still referring to FIGS. 1-7, the pipe coupling 10 also includes connection members positioned on each of the half-shells 12a, 12b at an end opposite to the pivot attachment 14. The connection members are adjustably tightenable for drawing the half-shells toward one another around the pair of pipe elements. This configuration allows joining and tightening of the two half shells 12a, 12b at a second end thereof. The connection members can include any type of attachment member that can allow for closing and securing the two half shells. In the embodiment shown at FIGS. 1-7, the connection members are embodied by a screw 20a provided at the second end of the first half shell 12a and a hole 20b provided at the second end of the second half shell 12b.

It should be understood that the connection members can have various configurations. For example, and as shown at FIG. 8, the connection members can be embodied by a clip 21a provided at the second end of the first half shell 12a and a hole 21b provided at the second end of the second half shell 12b.

In the embodiment shown at FIGS. 1-7, each contact surface 16a, 16b, 17a, 17b has a semi-cylindrical shape that is able to receive an end of a pipe element. For example, a lower half of an end of a first pipe can be provided against contact surface 16b and against a first lateral surface of lip member 18b. Similarly, a lower half of an end of a second pipe can be provided against contact surface 17b and against a second lateral surface of lip 18b. The pipe coupling 10 can then be closed around the first and second thermoplastic pipes (i.e., the pipe coupling 10 can be taken from an open state to a closed state) such that first contact surfaces 16a, 16b surround the end of the first pipe, such that second contact surfaces 17a, 17b surround the end of the second pipe. It should be understood that in some scenarios, the two thermoplastic pipes can each be in a fixed (or immovable) position with a gap therebetween, and the pipe coupling can be provided around the gap and the two pipe ends.

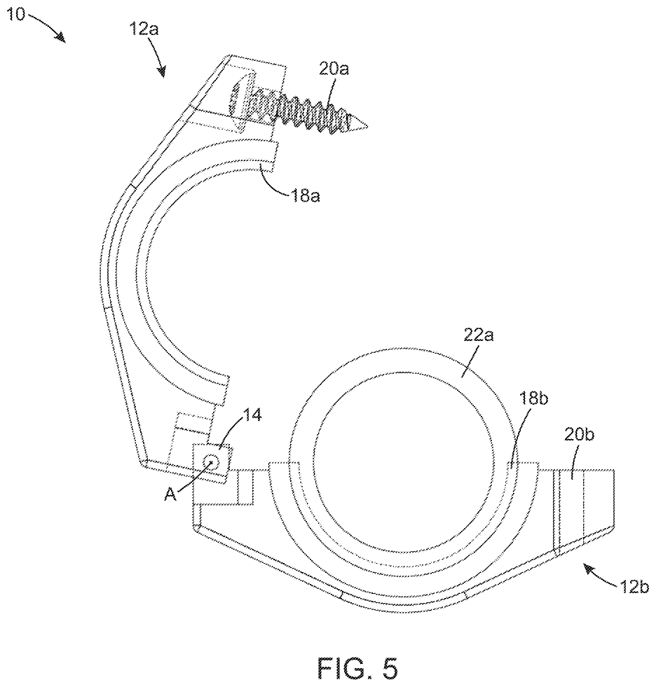

In some embodiments, the pipe elements are not socketed or grooved. In some embodiments the pipe elements are plain end pipe elements, such as plain end thermoplastic pipes 22a, 22b as shown at FIGS. 5-7. The pipe coupling of the present description can be used to sealably connect two thermoplastic pipes end-to-end, the two thermoplastic pipes, such as two DWV pipes, being separated by a gap. Preferably, the gap separating the two pipes is not to be closed off by moving the two thermoplastic pipes closer together. Rather, the pipe coupling of the present description can fill the gap (via the welding solvent). In other words, the expression “sealably connect two pipes end-to-end” is not to be interpreted as closing the gap between the two pipes by bringing the two pipes closer together, but rather as sealably fill the gap using the pipe coupling and welding solvent.

In some embodiments, the two pipes are made of a first thermoplastic material and the pipe coupling is made of a second thermoplastic material. The first thermoplastic material can be the same or different than the second thermoplastic material. When the first and second thermoplastic materials are different from one another, it is understood that the first and second thermoplastic materials are still compatible with each other, i.e., are able to be glued or solvent welded together.

The pipe coupling can also be referred to as a coupling clamp. The pipe coupling clamps the end of the first pipe element and end of the second pipe element. The welding solvent or adhesive then creates a sealed joint between the first pipe element, the second pipe element and the pipe coupling.

The pipe coupling of the present description can, after curing of the welding solvent or adhesive, leave no gap between the ends of the first and second pipe elements. This is advantageous compared to a traditional pipe coupling such as a stock coupling (e.g., a Fernco™ coupling) which can leave a gap between the ends of the first and second pipe elements and allow debris to accumulate, thereby creating a blockage. Traditional socket couplings also do not allow to obtain a proper glued connection when repairing or tying in a drain or vent in between a section of pipe, as DWV pipes typically are immobile or cannot be easily moved.

The present description also provides a method for securing end portions of a pair of pipe elements together end-to-end using the pipe coupling as defined herein. The method includes applying a welding solvent to at least one of an external surface of an end of the two pipe elements and to the contact surfaces of the pair of half-shells; positioning a first one of the half-shells around a respective end of the two pipe elements; pivoting the second one of the half-shells about the pivot attachment to connect the half-shells together via the connection member; and maintaining the pipe coupling in a closed position until the welding solvent forms a sealed connection between the pipe coupling and the two thermoplastic pipe elements. The two half-shells, when in the closed position around the ends of the first and second pipe elements, thereby clamp the ends of the first and second pipe elements.

The pipe coupling can be provided in various sizes, to fit existing pipe elements. Non-limiting examples of suitable sizes vary between 1½ to 6 inches.

The pipe couplings 10 of FIGS. 1-7 and FIG. 8 include a first half-shell 12a, also referred to as the male half-shell 12a including a male connector 20a, 21a at a connector end of the male half-shell 12a and a pivot attachment 14, 15 at a pivot end of the male half-shell. The pipe couplings 10 also include a second half-shell 12b, also referred to as the female half-shell 12b, that includes a female connector 20b, 21b at a connector end of the female half-shell 12b. The female half-shell 12b is attached to the pivot attachment 14, 15 at a pivot end of the female half-shell 12b. The female connector 20b, 21a is complimentary to the male connector 20a, 21a. In the embodiment of FIGS. 1-7, the male connector is a screw and the female connector is a corresponding groove. In the embodiment of FIG. 8, the male connector is a clip and the female connector is a corresponding hole or recess. It is understood that other types of corresponding male and female connectors may be used in other embodiments.

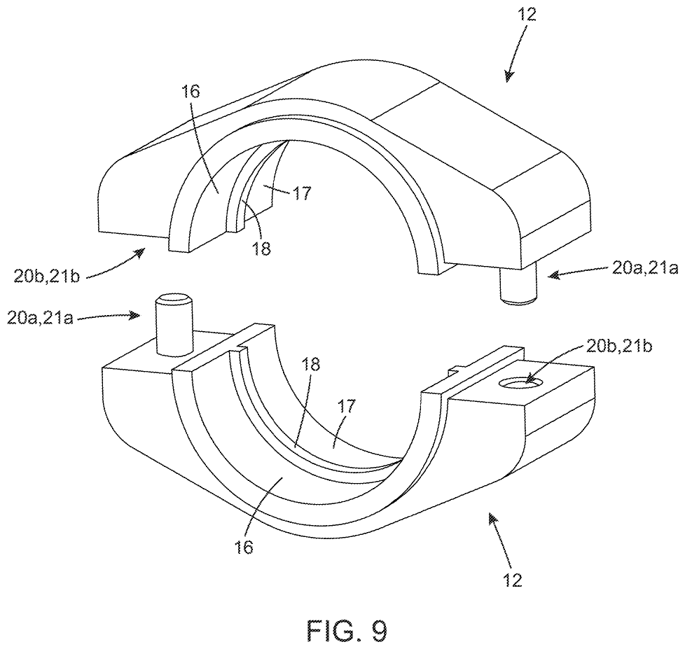

Now referring to FIG. 9, two half-shells 12 are shown. Each half-shell 12 has a male connector 20a, 21a at a male connector end thereof and a female connector 20b, 21b at a female connector end thereof. The two half-shells 12 of FIG. 10 are complimentary to one another and are not joined together by a pivot attachment, contrary to the half-shells 12a, 12b shown in FIGS. 1-7 and FIG. 8. The half-shells 12 each include contact surfaces 16, 17, similar to contact surfaces 16a, 16b, 17a, 17b of FIGS. 1-7 as well as a lip member 18 similar to lip members 18a, 18b of FIGS. 1-7. The male and female connectors of FIG. 9 can be a screw and a corresponding groove, as in FIGS. 1-7, or a clip and a corresponding hole or recess, as in FIG. 8. It is understood that other types of corresponding male and female connectors may be used in other embodiments.

A pipe coupling can be formed using two complimentary half-shells 12. Welding solvent or adhesive can be applied on at least one of an external surface of an end of the two pipe elements and the contact surfaces of the half-shells 12. A first half-shell 12 can then be placed around the first and second pipe elements, with the contact surfaces of the first half-shell 12 surrounding the end of the first and second pipes. A second half-shell 12 can then be placed around the first and second pipe elements in a complimentary manner with respect to the first half-shell 12. In other words, the male connector 20a, 21a of the first half-shell 12 is coupled with the female connector 20b, 21b of the second half-shell 12 and the female connector 20b, 21b of the first half-shell 12 is coupled with the male connector 20a, 21a of the second half-shell 12. The two half-shells 12 are coupled together around the end of the two pipe elements to form a pipe coupling. The welding solvent or adhesive then forms a sealed connection between the pipe coupling and the two pipe elements.

Finally, it should be understood that the expression “for use in a drain-waste-vent system” with reference to the pipe couplings of the present description, refers to the pipe couplings being used for sealably connecting two pipes of the drain-waste-vent system.

1. A pipe coupling for securing end portions of a pair of thermoplastic pipe elements together end-to-end, the pipe coupling comprising:
a first half-shell and a second half-shell each having a pivoting end and a connecting end opposite the pivoting end, the first half-shell and the second half-shell each defining a central space for receiving the pair of thermoplastic pipe elements, each one of the half-shells comprising a pair of contact surfaces facing the central space, each of the contact surfaces being engageable with a respective one of the thermoplastic pipe elements after application of a welding solvent to the contact surfaces and/or to an external surface of the thermoplastic pipe elements;
a pivot attachment pivotally connecting the half-shells to one another at the pivoting ends and enabling the half-shells to pivot with respect to one another between a closed state in which the connecting ends contact each other and an open state in which the connecting ends are apart from one another;
a first connector positioned at the connecting end of the first half-shell; and
a second connector positioned at the connecting end of the second half-shell, the first connector and the second connector being complimentary to one another and connectable to each other when the half-shells are in the closed state to maintain the half-shells in the closed state and enable the welding solvent to sealably weld the contact surfaces and the pipe elements together.

2. The pipe coupling of claim 1, wherein each half-shell further comprises a lip member separating the pair of surfaces, the lip member protruding away from the contact surfaces and into the central space.

3. The pipe coupling of claim 2, wherein the lip member of the first half-shell and the lip member of the second half-shell form together a circular protruding element when the pipe coupling is in the closed state, wherein a first one of the thermoplastic pipe elements abuts a first lateral surface of the circular protruding element, and a second one of the thermoplastic pipe elements abuts a second lateral surface of the circular protruding element.

4. The pipe coupling of claim 1, wherein the first connector is a male connector and the second connector is a female connector complimentary to the male connector.

5. The pipe coupling of claim 1, wherein the pivot attachment comprises a hinge having at least one bearing positioned on each one of the first and second half-shells, the bearings being connected by an axle.

6. The pipe coupling of claim 1, wherein the thermoplastic pipe elements are made of PVC, ABS, polycarbonate or polystyrene.

7. The pipe coupling of claim 1, wherein the contact surfaces are arcuate contact surfaces for fitting cylindrical thermoplastic pipes.

8. The pipe coupling of claim 1, wherein the pipe coupling is made of the same material as the thermoplastic pipe elements.

9. The pipe coupling of claim 1, wherein at least one of the first connector and the second connector is removable after the welding solvent sealably welds the contact surfaces and the pipe elements together.

10. The pipe coupling of claim 1, wherein the thermoplastic pipe elements are cylindrical thermoplastic pipes.

11. The pipe coupling of claim 1, wherein the end of each one of the pipe elements is a plain end.

12. The pipe coupling of claim 1, wherein the thermoplastic pipe elements are drain-waste-vent (DWV) pipes.

13. A method for securing end portions of a pair of thermoplastic pipe elements together end-to-end using the pipe coupling as defined in claim 1, the method comprising:
applying a welding solvent to at least one of the external surfaces of the thermoplastic pipe elements and to the contact surfaces of the first and second half-shells;
positioning the first half-shell around a respective end of each one of the thermoplastic pipe elements;
pivoting the second half-shell about the pivot attachment so that the pipe coupling is in the closed state; and
maintaining the pipe coupling in the closed state until the welding solvent forms a sealed connection between the pipe coupling and the thermoplastic pipe elements.
